(19) United States
(12) Patent Application Publication
(10) Pub. No.: US 2009/0307950 A1
(43) Pub. Date: Dec. 17, 2009

(54) KEY TAG

(76) Inventor: Kathleen M. Coupland, Atlanta, GA (US)

Correspondence Address: GEORGE R. REARDON, 3356 STATION COURT, LAWRENCVILLE, GA, 30044, US

(21) Appl. No.: 12/483,460

(22) Filed: Jun. 12, 2009

Related U.S. Application Data
(60) Provisional application No. 61/061,422, filed on Jun. 13, 2008.

(51) Int. Cl. G09F 3/00; G09F 19/00

(52) U.S. Cl. 40/634

(57) ABSTRACT

A key tag card and associated methods of inspiration, advertising, and marketing are provided. In one exemplary embodiment, the key tag card includes: a pair of key tags coupled one to another along a common edge, each key tag being generally rectangular in shape, having four edges, a front surface, and a rear surface, and having an aperture to receive a key ring or the like, and each key tag being separable one from another; a tab coupled to at least one edge of each of the pair of key tags, the tab being separable from each key tag; a card, formed by the pair of key tags and the tab; and an inspirational, affirmational, advertising, marketing or promotional message depicted on at least one of the front surface and the rear surface of each of key tags.

### CROSS-REFERENCE TO RELATED APPLICATION(S)

The present non-provisional patent application claims the benefit of priority of U.S. Provisional Patent Application No. 61/061,422, which is entitled “KEY TAG”, which was filed on Jun. 13, 2008, and which is incorporated in full by reference herein.

### FIELD OF THE INVENTION

The technology described herein relates generally to the fields of key tags and portable, mobile advertising, marketing, promotion, and inspiration. More specifically, this technology relates to a key tag card having multiple key tags, each key tag configured for holding a key, article, or the like, and a method for portable, mobile advertising, marketing, promotion, and inspiration utilizing a key tag card and one or more key tags.

### BACKGROUND OF THE INVENTION

Key tags are utilized typically in combination with a set of keys, or the like. Key tags are known for the identification of keys.

Related patents known in the art include the following: U.S. Pat. No. 7,004,441, issued to Rutland on Feb. 28, 2006, discloses a clippable plastic note. U.S. Published Patent Application No. 2003/0200687, discloses a keychain assembly and method of use the same.

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a key tag card having key tags and associated methods of inspiration, advertising, and marketing.

In one exemplary embodiment, the technology described herein provides a key tag card. The key tag card includes: a pair of key tags coupled one to another along a common edge, each key tag being generally rectangular in shape, having four edges, a front surface, and a rear surface, and having an aperture to receive a key ring or the like, and each key tag being separable one from another; a tab coupled to at least one edge of each of the pair of key tags, the tab being separable from each key tag; a card, formed by the pair of key tags and the tab; and a message depicted on at least one of the front surface and the rear surface of each of key tags.

The key tag card can include a textual, inspirational message with the author and citation. The key tag card can include an inspirational image.

The key tag card can include an inspirational message on the front surface of the key tag and an affirmation on the rear surface of the key tag.

The key tag card can include a first message on one key tag of the pair of key tags and a second message one the other key tag of the pair of key tags, wherein the first message and second message are not identical yet are contextually paired to form a matching set.

The key tag card can include a business identity on the front surface of the key tag and a vision and mission statement on the rear surface of the key tag.

The key tag card can be configured for use in fundraising. As such the key tag card can include a mascot of a sports team organization on the front surface of the key tag and a component of team information on the rear surface of the key tag.

The key tag card can be configured for use in the recognition of pets. As such the key tag card can include an image of a pet on the front surface of the key tag and a component of pet information on the rear surface of the key tag.

The tab of the key tag card can further include a uniform product code.

The key tag card formed by the pair of key tags and the tab can include an inspirational greeting card that is separable into two key tags.

In another exemplary embodiment, the technology described herein provides a method of inspirational advertising and marketing. The method includes utilizing a key tag card comprising: a pair of key tags coupled one to another along a common edge, each key tag being generally rectangular in shape, having four edges and a front surface and a rear surface, and having an aperture to receive a key ring or the like, and each key tag being separable one from another; a tab coupled to at least one end of each of the pair of key tags, the tab being separable from each key tag; and a card, formed by the pair of key tags and the tab; and placing a message on at least one of the front surface and the rear surface of each of key tags.

The method can further include utilizing the key tag card for the purpose of inspiration and placing an inspirational message on the front surface of the key tag and an affirmation on the rear surface of the key tag.

The method can further include utilizing the key tag card for the purpose of creating a matching set of key tags, wherein the message further includes a first message on one key tag of the pair of key tags and a second message one the other key tag of the pair of key tags, and wherein the first message and second message are not identical yet are contextually paired.

The method can further include utilizing the key tag card for the purpose of advertising and marketing, wherein the message further includes a business identity on the front surface of the key tag and a vision and mission statement on the rear surface of the key tag.

The method can further include utilizing the key tag card for the purpose of fundraising, wherein the message further includes a mascot of a sports team organization on the front surface of the key tag and a component of team information on the rear surface of the key tag.

The method can further include utilizing the key tag card for the purpose of recognizing and promoting pets, wherein the message further includes an image of a pet on the front surface of the key tag and a component of pet information on the rear surface of the key tag.

The method can further include utilizing the key tag card to provide an inspirational greeting card that is separable into two key tags, each key tag having an inspirational message.

The method can further include utilizing the key tag card to provide matching luggage tags.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a front perspective view of a key tag, illustrating, in particular, a key tag attached to a key chain and a key, according to an embodiment of the technology described herein;

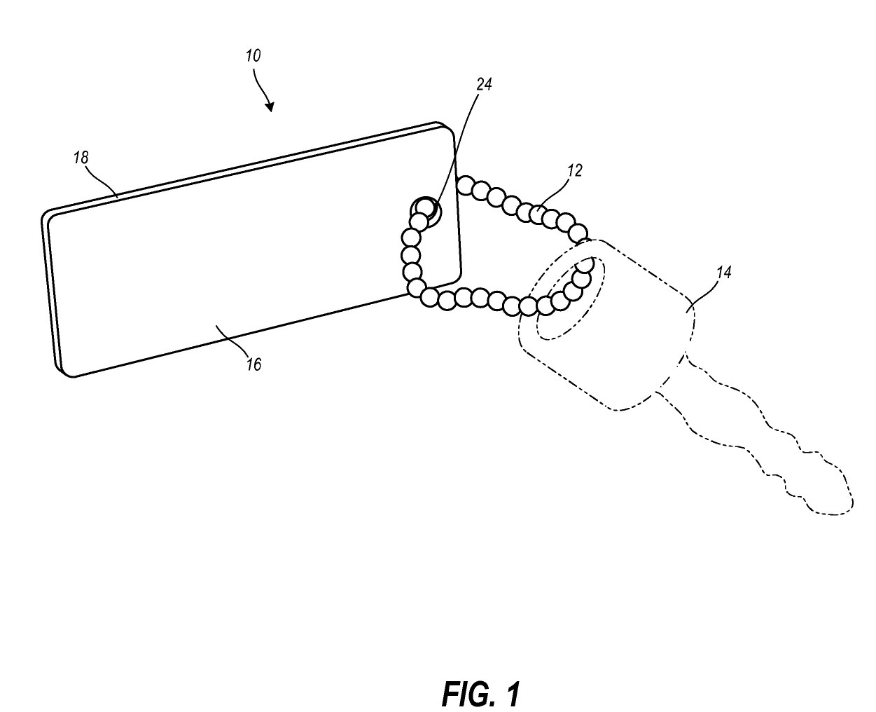

FIG. 2 is a front perspective view of a key tag card, illustrating, in particular, a pair of key tags and a tab, according to an embodiment of the technology described herein;

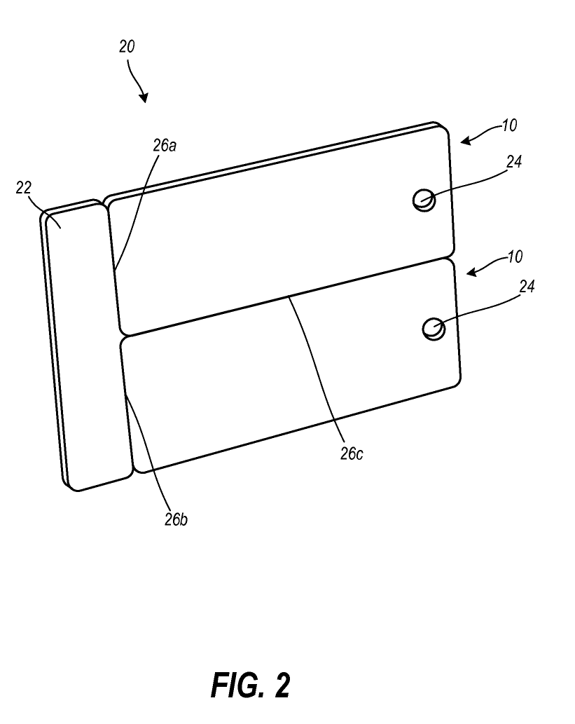

FIG. 3 is a front perspective view of the key tag card depicted in FIG. 2, illustrating in particular, the separation process for removing the tab and separating the two key tags, according to an embodiment of the technology described herein;

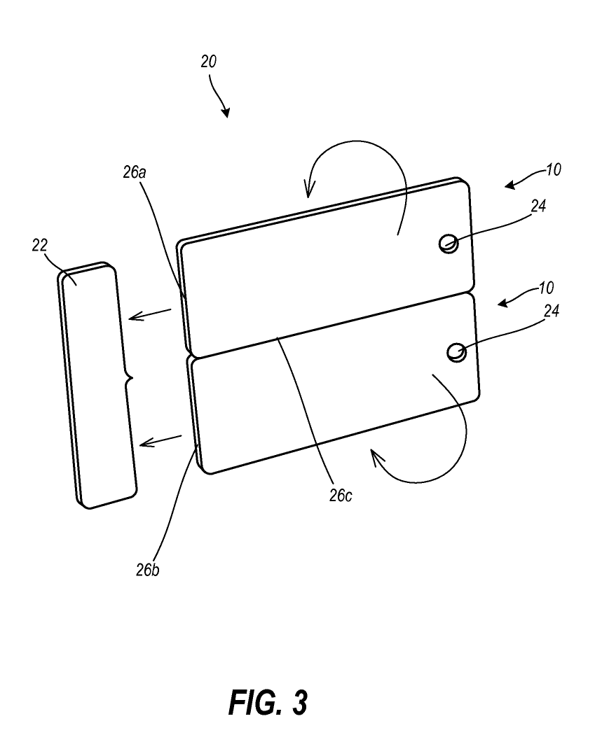

FIG. 4 is a front perspective view of a single key tag after removal from a key tag assembly depicted in FIG. 3, and illustrating, in particular, an image, according to an embodiment of the technology described herein;

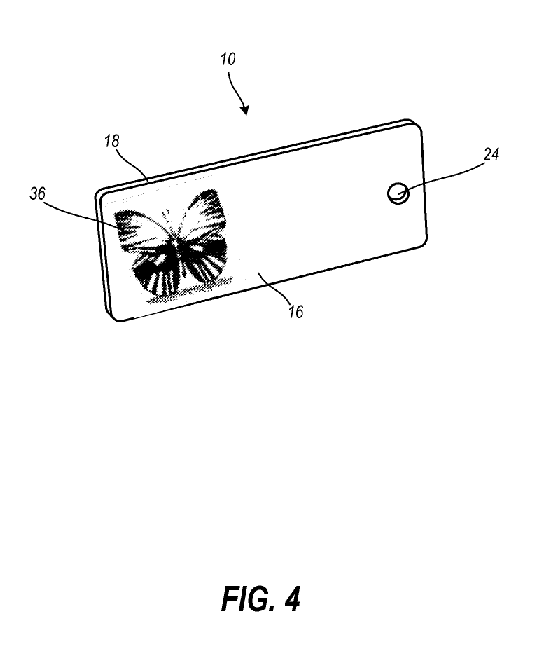

FIG. 5 is a front perspective view of a retail display system for the marketing, promotion, and sales of key tags, according to an embodiment of the technology described herein;

FIG. 6 is a front planar view of a key tag card, illustrating, in particular, an inspirational message common to both key tags contained therein, according to an embodiment of the technology described herein;

FIG. 7 is a rear planar view of a key tag card, illustrating, in particular, an affirmation common to both key tags contained therein, according to an embodiment of the technology described herein; and

FIG. 8 is a flowchart diagram depicting a method of marketing and advertising utilizing a key tag card, according to an embodiment of the technology described herein.

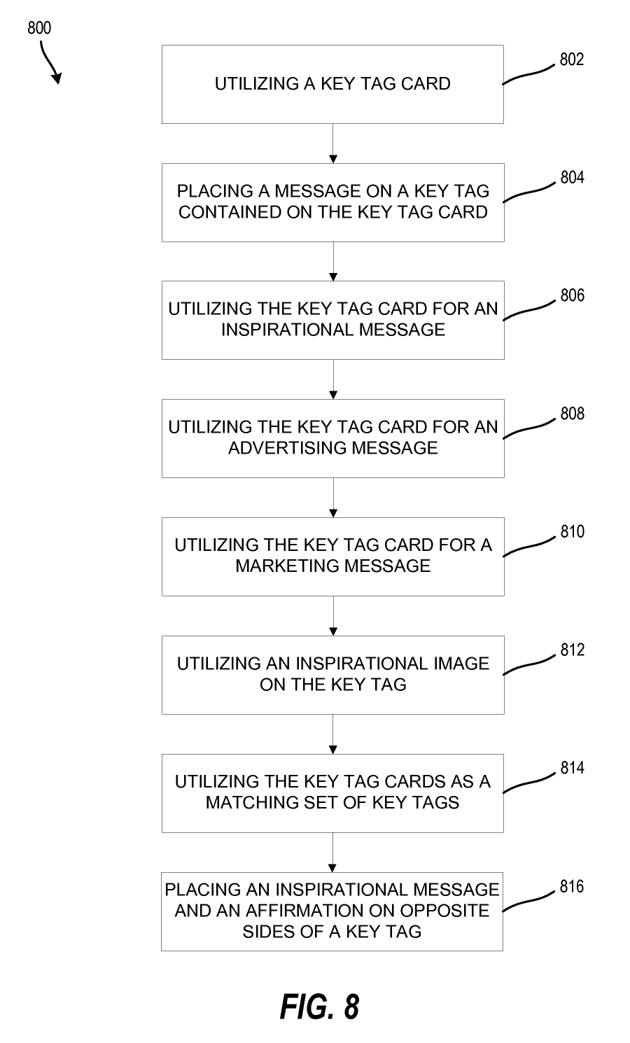

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a key tag card having key tags and associated methods of inspiration, advertising, and marketing.

Referring now to the Figures, a key tag card 20 is shown. The key tag card 20 includes a pair of key tags 10 coupled one to another along a common edge. Each key tag 10 is generally rectangular in shape. Each key tag 10 has four edges 18, a front surface 16, and a rear surface 42. Each key tag card 20 is manufactured from a plastic material, or the like, that is suitable for fanciful, two-sided printing in color and with images. As will be apparent to those of ordinary skill in the art, the key tags 10 can be formed in other, non-rectangular shapes, and the key tag card 20 also can be formed in non-rectangular shapes.

Each key tag 10 has an aperture 24 to receive a key chain 12, key ring, loop, or the like, configured to hold one or more key 14, or otherwise attach to a luggage handle, gift box, card, or the like. As will be apparent to those of ordinary skill in the art, the key tags 10 can be utilized to hold items other than keys. By way of example, the key tag cards 20 and the key tags 10 can be utilized as gifts, card stuffers, stocking stuffers, gift tags, luggage tags, and the like.

The key tag card 20 includes a tab 22 coupled to at least one edge 18 of each of the pair of key tags 10. The tab 22 is separable from each key tag 10 along lines 26a, 26b. The tab 22 can include tab text 38. The tab text 38 can be varied, but can, for example, include a logo, image, text, name, trademark, saying, or the like. The tab 22 of the key tag card 20 can further include a uniform product code (UPC) 40. The UPC 40 is useful in retailing the key tag cards 20. Each key tag card 20 can utilize a unique UPC 40. The key tag card 20 is a card that is formed by the pair of key tags 10 and the tab 22.

The key tags 10 and the tab 22 in each key tag card 20 can be formed from the same piece of manufacturing material by a stamping process, or the like. Each key tag 10 in the key tag card 20 is separable one from another. By way of example, separation lines 26a, 26b, 26c, provide lines, such as perforation lines, upon which the key tags 10 and the tab 22 can be rotated and separated from one another.

The key tag card 20 includes a message 32 depicted on at least one of the front surface 16 and the rear surface 42 of each of key tags 10. The message 32 can be selected based on the intent of use of the key tag card 20. By way of example, message 32 can include inspirational comments, marketing and advertising text, corporate names and logos, sporting teams, mascots, fight songs, fundraising initiative information, pets, pet information, support for troops, support for causes and awareness, and the like.

The key tag card 20 can include a textual, inspirational message 32 with the author and citation. By way of example, a key tag 10 can include the inspirational message 32 stating “When you change the way you look at things, the things you look at change.” The message 32 would cite Max Plank, Nobel Prize Winner. The key tag card 20 also can include an inspirational image 36, or the like. The inspirational image 36 can relate to the inspirational message 32 in context, or be varied.

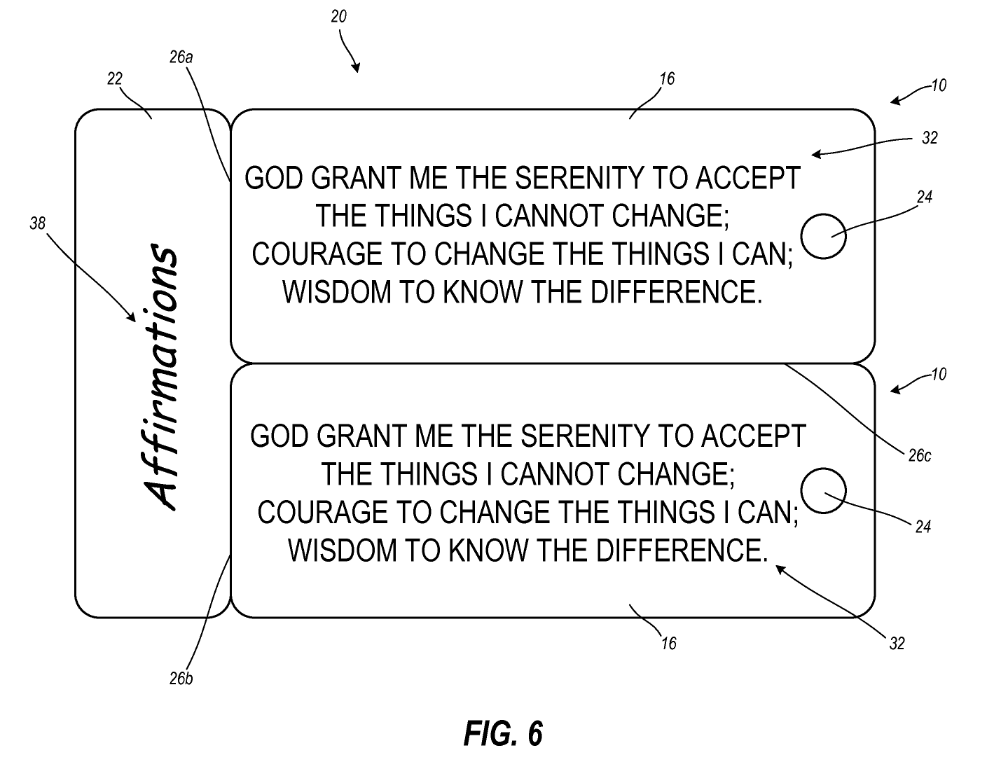

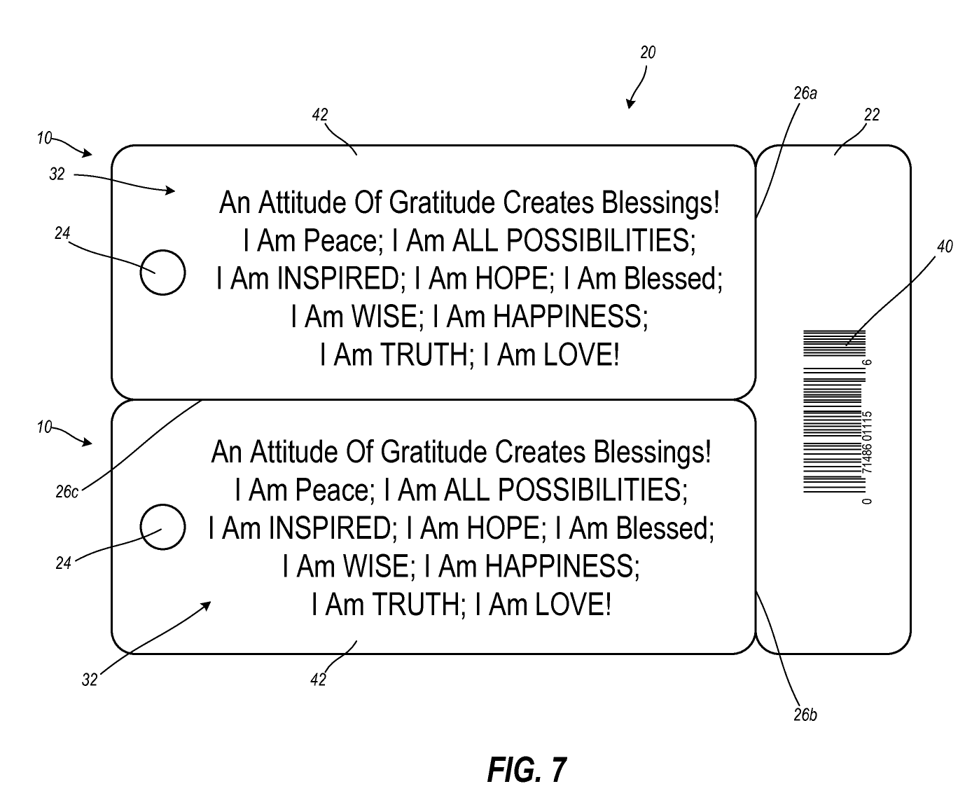

The key tag card 20 can include an inspirational message (message 32 in FIG. 6, for example) on the front surface 16 of the key tag 10 and an affirmation (message 32 in FIG. 7, for example) on the rear surface 42 of the key tag 10. By way of example, the key tag 10 can include the message 32 on front surface 16 stating “If I change my mind, I change my choices; if I change my choices, I change my life. Be the change you wish to see in the world” by Mahatma Gandhi, and include the affirmation message 32 on the rear surface 42 stating “An Attitude of Gratitude creates Blessings!; I am Peace; I am ALL POSSIBILITIES; I am INSPIRED; I am HOPE; I am Blessed; I am WISE; I am HAPPINESS; I am TRUTH; I am LOVE!”

The key tag card 20 can include a first message on one key tag of the pair of key tags and a second message one the other key tag of the pair of key tags. In this embodiment, the first message and second message are not identical yet are contextually paired to form a matching set, such as a “his-and-her” set.

The key tag card 20 can include a business identity on the front surface 16 of the key tag 10 and a vision and mission statement on the rear surface of the key tag. By way of example, one side of the key tag 10 can include a corporate name and logo and the opposite side of the key tag 10 can include a mission and/or vision statement.

The key tag card 20 can be configured for use in fundraising. As such the key tag card 20 can include a mascot of a sports team organization on the front surface 16 of the key tag 10 and a component of team information on the rear surface 42 of the key tag 10. By way of example, one side of the key tag 10 can include a team mascot for a collegiate sports team, and the opposite side of the key tag 10 can include a fight song, or the like.

The key tag card 20 can be configured for use in the recognition of pets. As such the key tag card 20 can include an image of a pet on the front surface 16 of the key tag 10 and a component of pet information on the rear surface 42 of the key tag 10.

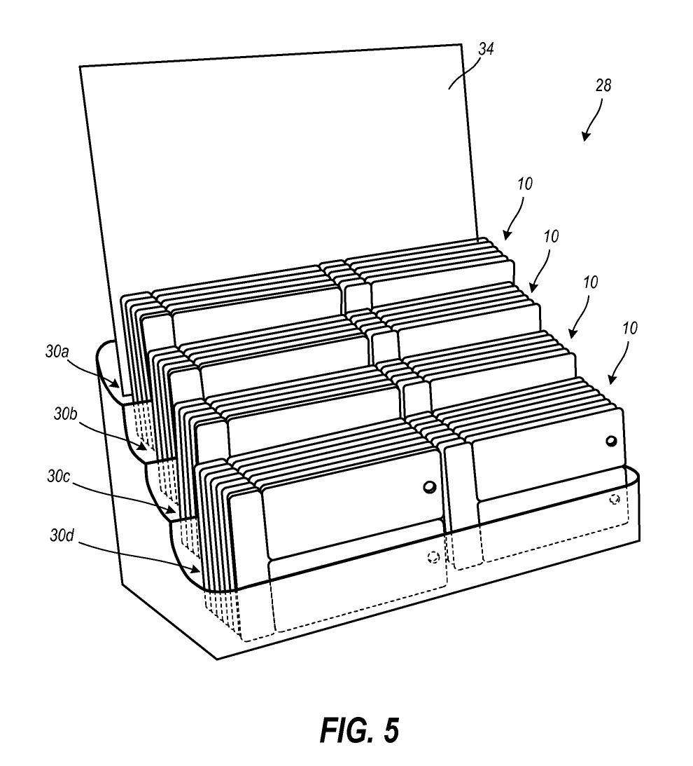

The key tag card 20 can be marketed, advertised, sold, and the like, utilizing a retail display system 28. The retail display system 28 includes a display panel 34 than is utilized for information and advertising. The retail display system 28 also includes pockets 30a, 30b, 30c, 30d, for example, in which to place key tag cards 20. The retail display system 28 depicted in FIG. 5 is shown with eight pockets.

By way of example, the retail display system 28 can be utilized to market eight different types of key tag cards 20 in the various pockets 30. In at least one embodiment, the retail display system 28 includes a total footprint of 7¾″ w×3¾″ h×3-34″ d. This is an ideal display size for any business counter top, shelf, or the like. Additionally, stickers (not shown) can be utilized to attract customers to the retail display system 28.

In at least one embodiment, the retail display system 28 includes two self-adhesive display cards, such as display 34, that graphically show the key tag 10 being used on a key chain 12 and on a gift bag. These display cards offer ideas on how the ket tag cards 20 can be used.

A method of inspirational advertising and marketing is provided. An exemplary method is depicted in flowchart 800. The method includes, in task 802, utilizing a key tag card 20. The key tag card 20 includes: a pair of key tags 10 coupled one to another along a common edge 18, each key tag 10 being generally rectangular in shape, having four edges 18 and a front surface 16 and a rear surface 42, and having an aperture 24 to receive a key chain 12, key ring, or the like, and each key tag 10 being separable one from another; a tab 22 coupled to at least one end of each of the pair of key tags 10, the tab 22 being separable from each key tag; and a card, formed by the pair of key tags 10 and the tab 22; and, in task 804, placing a message 32 on at least one of the front surface 16 and the rear surface 42 of each of key tags 10.

The method can further include, in task 806, utilizing the key tag card 20 for an inspirational message 32.

The method can further include, in task 808, utilizing the key tag card 20 for an advertising message.

The method can further include, in task 810, utilizing the key tag card 20 for a marketing message.

The method can further include, in task 812, utilizing the key tag card 20 for the purpose of including an inspirational image 36.

The method can further include, in task 814, utilizing the key tag card 20 for the purpose using the key tags 10 as a matching set of key tags 10.

The method can further include, in task 816, utilizing the key tag card 20 for the purpose of inspiration and placing an inspirational message on the front surface of the key tag and an affirmation on the rear surface of the key tag.

It will be apparent to those skilled in the art, after reading this disclosure, which methods steps disclosed can be performed simultaneously or in a different order than that depicted, or omitted given the nature of a particular desired communication with the key tag 10.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A key tag card comprising:
a pair of key tags coupled one to another along a common edge, each key tag being generally rectangular in shape, having four edges, a front surface, and a rear surface, and having an aperture to receive a key ring or the like, and each key tag being separable one from another;
a tab coupled to at least one edge of each of the pair of key tags, the tab being separable from each key tag;
a card, formed by the pair of key tags and the tab; and
a message depicted on at least one of the front surface and the rear surface of each of key tags.

2. The key tag card of claim 1, wherein the message further comprises a textual, inspirational message.

3. The key tag card of claim 2, wherein the message further comprises at least one of an author and a citation related to the textual, inspirational message.

4. The key tag card of claim 1, wherein the message further comprises an inspirational image.

5. The key tag card of claim 1, wherein the message further comprises an inspirational message on the front surface of the key tag and an affirmation on the rear surface of the key tag.

6. The key tag card of claim 1, wherein the message further comprises a first message on one key tag of the pair of key tags and a second message one the other key tag of the pair of key tags, and wherein the first message and second message are not identical yet are contextually paired to form a matching set.

7. The key tag card of claim 1, wherein the message further comprises a business identity on the front surface of the key tag and a vision and mission statement on the rear surface of the key tag.

8. The key tag card of claim 1, wherein the key tag card is configured for use in fundraising, and wherein the message further comprises a mascot of a sports team organization on the front surface of the key tag and a component of team information on the rear surface of the key tag.

9. The key tag card of claim 1, wherein the key tag card is configured for use in recognition of pets, and wherein the message further comprises an image of a pet on the front surface of the key tag and a component of pet information on the rear surface of the key tag.

10. The key tag card of claim 1, wherein the tab further comprises a uniform product code.

11. The key tag card of claim 1, wherein the card formed by the pair of key tags and the tab is an inspirational greeting card that is separable into two key tags.

12. A method of inspirational advertising and marketing, the method comprising:
utilizing a key tag card comprising:
a pair of key tags coupled one to another along a common edge, each key tag being generally rectangular in shape, having four edges and a front surface and a rear surface, and having an aperture to receive a key ring or the like, and each key tag being separable one from another;
a tab coupled to at least one end of each of the pair of key tags, the tab being separable from each key tag;
a card, formed by the pair of key tags and the tab; and
placing a message on at least one of the front surface and the rear surface of each of key tags.

13. The method of claim 12, further comprising:
utilizing the key tag card for the purpose of inspiration; and
placing an inspirational message on the front surface of the key tag and an affirmation on the rear surface of the key tag.

14. The method of claim 12, further comprising:
utilizing the key tag card for the purpose of creating a matching set of key tags, wherein the message further comprises a first message on one key tag of the pair of key tags and a second message one the other key tag of the pair of key tags, and wherein the first message and second message are not identical yet are contextually paired.

15. The method of claim 12, further comprising:
utilizing the key tag card for the purpose of advertising and marketing, wherein the message further comprises a business identity on the front surface of the key tag and a vision and mission statement on the rear surface of the key tag.

16. The method of claim 12, further comprising:
utilizing the key tag card for the purpose of fundraising, wherein the message further comprises a mascot of a sports team organization on the front surface of the key tag and a component of team information on the rear surface of the key tag.

17. The method of claim 12, further comprising:
utilizing the key tag card for the purpose of recognizing and promoting pets, wherein the message further comprises an image of a pet on the front surface of the key tag and a component of pet information on the rear surface of the key tag.

18. The method of claim 12, further comprising:
utilizing the key tag card to provide an inspirational greeting card that is separable into two key tags, each key tag having an inspirational message.

19. The method of claim 12, further comprising:
utilizing the key tag card to provide matching luggage tags.

20. The method of claim 12, wherein the message further comprises an inspirational image.
